(19) United States
(12) Patent Application Publication
(10) Pub. No.: US 2007/0192120 A1
(43) Pub. Date: Aug. 16, 2007

(54) System and method for determining current replacement values for new or existing landscape architectural objects

(75) Inventors: Douglas W. Cowles, Cary, NC (US); Margaret Boccieri, Chapel Hill, NC (US); Wendy Lapish, Apex, NC (US); Natalie Fussell, Cary, NC (US); Mark Wood, Knightdale, NC (US); C. Thomas Hendrickson, Zebulon, NC (US)

Correspondence Address: GREENBERG TRAURIG, LLP, 1750 TYSONS BOULEVARD, 12TH FLOOR, MCLEAN, VA, 22102, US

(73) Assignee: Horticultural Asset Management, Inc., Raleigh, NC (US)

(21) Appl. No.: 11/524,518

(22) Filed: Sep. 21, 2006

Related U.S. Application Data
(63) Continuation-in-part of application No. 10/719,741, filed on Nov. 21, 2003.
(63) Continuation-in-part of application No. 10/642,865, filed on Aug. 18, 2003.
(60) Provisional application No. 60/718,747, filed on Sep. 21, 2005.

(51) Int. Cl. G06Q 10/00

(52) U.S. Cl. 705/1

(57) ABSTRACT

Disclosed is a system and method for determining the current replacement value of plants, trees, shrubs, and other landscape architectural objects by identifying the object; uploading information about the object and its location to a relational database which is used to construct average current replacement values; using the database to compare identified landscape architectural objects of a specific type and at a specific size against known wholesale pricing information from nurseries across the country to select valid nursery prices; averaging all valid prices for landscape architectural objects at a single nursery to derive a nursery average; extrapolating and interpolating price points at sizes not being sold by the nursery to create a complete size/price curve for a nursery; averaging that nursery curve with all other valid nursery prices to construct a national, and regional, average; and applying a market-based multiplier against the derived average wholesale prices to accommodate for the professional installation of the landscape architectural object.

### PRIORITY CLAIM AND NOTICE

This application claims the benefit of the filing date of U.S. Provisional Patent Application No. 60/718,747 filed Sep. 21, 2005, the entire disclosure of which is incorporated herein by reference. This application is a continuation-in-part of U.S. patent application Ser. No. 10/719,741 filed Nov. 21, 2003, and U.S. patent application Ser. No. 10/642,865 filed Aug. 18, 2003, which are incorporated herein by reference in their entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the fields of valuation and insurance products, and in particular to a novel method and system for determining the current replacement value of horticultural assets.

### BACKGROUND

Landscape architectures are arrangements of landscape architectural objects (natural and/or structural) in a landscape architectural setting developed for human use and enjoyment. A landscape architecture can include both an aesthetic component, e.g., the arrangement of the landscape architectural objects and/or the setting, and a physical component, e.g., the landscape architectural objects and the setting themselves. Landscape architectures not only greatly contribute to our environment and quality of life, but can add significant value to commercial and residential property.

Most property owners are not aware of the value of their trees and shrubs until they attempt to replace them following a loss. Replacing even a single average-size tree can cost $20,000 or more. Each year, billions of dollars are spent on developing landscape architectural settings in the United States for homes, businesses, parks, schools, streets, and the like. Despite knowing the amount of money spent on the landscape architectural objects and the setting at the time such improvements are made, there exists no consistent system and method for determining a current value of the objects as included in the landscape architectural setting.

It is estimated that approximately twenty million appraisals are performed annually in the United States in connection with the financing, purchasing, or insuring of real estate. In each of these appraisals, a generally subjective and arbitrary value is typically assigned to the landscape architectural settings associated with the real estate. Rather than driving the overall appraised value of the real estate, as occurs with other real property improvements such as building additions, the value of a landscape architectural setting is typically assessed to be an arbitrary percentage, e.g., seven percent, of a final appraised real estate value.

Various methods of valuing landscape architectures focus on a current cost of the landscape architectural objects included in a particular landscape architectural setting. These methods can overlook an aggregate value contribution of the objects to a landscape architecture, and an appreciation in value that can occur as the objects mature in a landscape architectural setting. As a result, the values assigned to landscape architectural settings are inconsistent and inaccurate, and are thus unreliable.

Without access to standardized value information and methods for determining the value of landscape architectural settings, insurance and financing institutions can have little confidence in the accuracy of the resulting values assigned to landscape architectural objects and settings. As a result, owners of residential and commercial real estate have been unable to realize the full added value gained by investing in their landscape architectural settings.

The establishment of such standards and methods can give insurance and financing institutions the tools needed to consistently value landscape architectural objects and settings in an objective, non-arbitrary manner. Consequently, owners of residential and commercial real estate investing in their landscape architectural settings could receive the full benefit of their investments, such as an ability to fully insure or collateralize their landscape architectural objects and settings.

Having access to accurate replacement cost values will also aid property owners in establishing casualty loss values for income tax, insurance, legal and other needs following a loss of landscape architectural objects and settings.

Consistent and accurate landscape architecture valuation can also lead to an increased awareness among property owners of a need to protect their investment in a landscape architectural setting through development, care, and maintenance programs. This increased awareness can in turn lead to an increased demand for landscape maintenance services, inspections, and other services performed in connection with ensuring the proper development of landscape architectures.

Moreover, knowledge of the value of an investment in landscape development at some time in the future can aid property owners in making more informed decisions regarding the current costs and returns on investment associated with various capital improvement projects.

### SUMMARY OF THE INVENTION

In one embodiment, the invention provides a system and method for determining the current replacement value of plants, trees, shrubs, and other landscape features (hereinafter “landscape architectural objects”) by identifying the landscape architectural object; uploading information about the landscape architectural object and its location to a relational database which is used to construct average current replacement values; using the database to compare identified landscape architectural objects of a specific type and at a specific size against known wholesale pricing information from nurseries across the country to select valid nursery prices; averaging all valid prices for individual species and/or cultivars at a single nursery to derive a nursery average; extrapolating and interpolating price points at sizes not being sold by the nursery to create a complete size/price curve for a nursery; utilizing a cost of living adjustment (COLA) to normalize the nursery data to a national average, averaging that nursery curve with all other valid nursery normalized prices to construct a national average; and applying a market-based multiplier against the derived average wholesale prices to accommodate for the professional installation of the landscape architectural object: further utilizing a COLA upon data output to create regional/local replacement cost values for each property owner.

### BRIEF DESCRIPTION OF THE DRAWINGS

FIGS. 1A and 1B show a flow diagram illustrating the method for determining current replacement values in accordance with the invention in one embodiment.

### DETAILED DESCRIPTION OF THE PREFERRED EMBODIMENT

Reference will now be made in detail to the preferred embodiments of the present invention, examples of which are illustrated in the accompanying drawings.

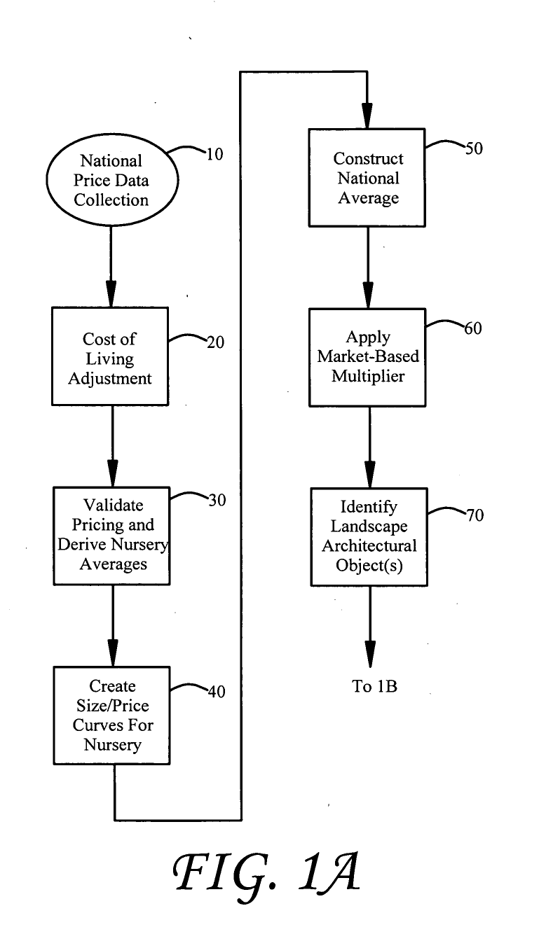

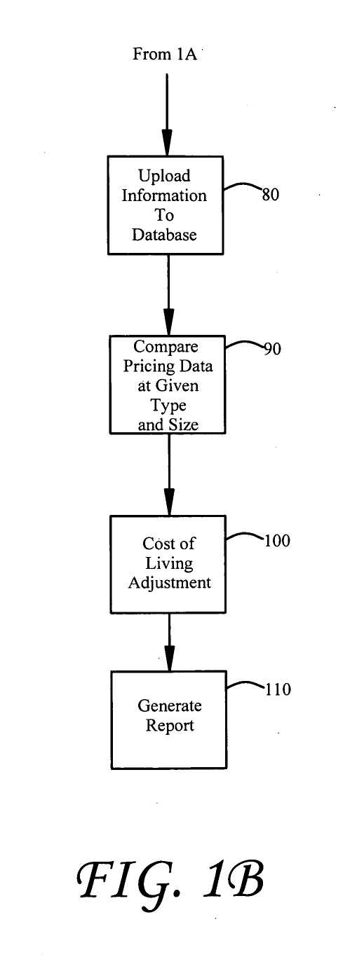

With reference to FIG. 1A, the method of the invention in one embodiment begins with the collection of wholesale-based pricing nationwide to aggregate a critical mass of pricing data on a sufficient number of different landscape architectural objects as contemplated in step 10.

At step 20, a Cost of Living Adjustment is applied against all prices entered into the system. The COLA will normalize all pricing to a national average as determined by cost of living data for green industry purchases as provided by commercially available demographics data software.

At step 30, the system uses business rules to validate the pricing information collected from nurseries. The business rules in one embodiment expose outlying prices by plant and by nursery. The system also validates progressive prices at increasing plant size by monitoring prices per size metric to again identify outliers or data entry irregularities. In the database, like species and cultivars may be grouped or otherwise associated together, which enables one to use many actual price data points to construct a current value. Following the systems' selection of valid nursery prices, the system averages all valid prices for species and cultivars at a single nursery to derive a nursery average. The system then extrapolates and interpolates price points at sizes not being sold by the nursery, up to the maximum commercially available size.

At step 40, the process creates a complete size/price curve for a nursery. The system of the invention in one embodiment then, at step 50, averages that nursery price curve with all other valid nursery price curves to construct a national average.

At step 60 the system applies a market-based multiplier against the derived average wholesale prices to accommodate for the professional installation of the plant.

At step 70 landscape architectural objects for which a current value is to be determined may be assessed by a trained industry professional or provided by the property owner independently.

With reference to FIG. 1B, at step 80, following identification of the specific landscape architectural object, the information (type, size, general health, etc.) about the landscape architectural object and property location are uploaded to a relational database.

The database is used at step 90 to compare identified plants of a specific type and at a specific size against known wholesale pricing information from nursery data collected as described above. For landscape architectural objects that are larger than the maximum commercially available size, the system of the invention determines a price per size metric (price/sq. ft.) and applies that value against the size of the tree being assessed. This is consistent with a component of the Trunk Formula Method of tree appraisals that is used by most arborists in the U.S.

At step 100, following the creation of national average replacement cost values for each landscape architectural object identified on a property, the system will again apply a Cost of Living Adjustment to purpose the replacement values to the local/regional market where the property is located.

Finally, at step 110, a report is generated.

The following data structure requirements and business rules provide an example of a logic structure for the system of the invention, and provide a description of a method for ensuring accuracy of the valuation methods disclosed herein.

Data Structure Requirements

The system of the invention in certain embodiments enables the user to identify unique wholesale prices, aggregate wholesale prices to provide national and regional/local averages, select nursery prices reflective of “Standard” quality and “Premium” quality plants, purpose output towards a specific distribution channel, restrict extrapolation to landscape architectural objects within a desired number of feet, use qualified pricing data across multiple plant types, apply unique price multipliers based on a nursery or plant classification, evaluate each derived Plant Group pricing vertical, and “lock-in” a Plant Group price/size vertical for a specific time period. Each of these functions is discussed in more detail below.

The system and method can allow the user to identify unique wholesale prices. Such wholesale prices can be identified, e.g., by Plant (Genus, Species, Cultivar, Hybrid), Plant Characteristics (Tree, Shrub, Topiary, Bare Root, etc.), Size Type (Container, Height, Caliper), Nursery (Name, Location by state or region, Catalogue), classification (e.g., 0, 1, 2, 3), and Price (Standard or Premium).

The user can use the system and method to aggregate wholesale prices to provide national averages. A minimum of three valid nurseries with standard prices or three valid nurseries with premium prices may be required within discreet size classifications, such as Class 1 (small), 2 (medium) and 3 (large) for every plant group. This creates a minimum requirement of valid data points for each plant group and size type. The System can construct pricing verticals by nursery and class, and then average the individual verticals to construct a group vertical by class. The System identifies Plant Groups (PG's) (see below) for which Class 2 or Class 3 pricing is not applicable by evaluating the maximum size of plants in the Group. If necessary the system can remove the need for pricing in Class 2, Class 3, or both sizes and approve the PG based on relevant prices. For transitional plant sizes across class boundaries, the system selects group prices at specific points to interpolate. For example: Trees (7′ and 11′; 19′ and 23′) and Shrubs (3′ and 5′; 7′ and 11′). The system may be provided with the ability to generate exception reports as required for auditing.

Within each Class, the system may select, based on business rules, the nursery prices reflective of “Standard” quality and “Premium” quality plants. Once selected, the system may construct independent price verticals based on Standard and Premium prices. The system assigns each nursery price vertical a unique value based upon the average of all price points within the vertical, and selects the nursery price vertical with the highest assigned value together with all nursery price verticals with assigned values within a set percentage of the highest to become the “Premium” price verticals for a Plant Group. The System may require a minimum of two Premium price verticals and two Standard price verticals for approval of the Class price verticals for premium and standard prices. For catalogs that contain both Standard and Premium price points for the same plant, data entry rules dictate that two prices be entered, with the lower price as Standard and the higher as Premium. This will result in two price verticals being created for a single nursery in a particular Plant Group. If the two price verticals ultimately fall into either the Standard or Premium Group price vertical, the system averages those two verticals together at the nursery level before calculating the Group vertical.

In accordance with one embodiment of the invention, output can be purposed toward a specific distribution channel as determined by a Channel ID provided at the point of data input. The system may, e.g., provide pricing as follows:
1. Class 1, 2, 3 standard
2. Class 1, 2, 3 premium
3. Total Group

The system and method in one embodiment performs regional price averaging. In this respect, a business rule may be provided whereby each plant group requires two nurseries from each region. This will increase the number of required data points by a factor of 4. To accommodate this data entry requirement, the system is provided with the capability of grouping nurseries into regions, and generate exception reports as required for auditing. Regions may be defined, e.g., as follows:
i. Northeast: CT, ME, MA, NH, RI, VT, NJ, NY, PA
ii. South: DE, FL, GA, MD, NC, SC, VA, WV, AL, KY, MS, TN, AK, LA , OK, TX
iii. Midwest: IN, IL, MI, OH, WI, IA, KS, MN, MO, NE, ND, SD
iv. West: AZ, CO, ID, NM, MT, UT, NV, WY, AK, CA, HI, OR, WA

The system and method in one embodiment normalizes all pricing data input using available cost of living data to a national price average. It will then apply the same cost of living adjustment upon production of a specific replacement cost value report to reflect local/regional prices for the property being assessed.

One or more business rules may be provided for preventing the system from performing extrapolation beyond a specific size range for both trees and shrubs. Exception reports may be generated as required for auditing.

Wholesale prices from within the price database may be selected and combined within pre-determined Plant Groups to enable the user to use qualified pricing data across multiple plant types, primarily at the cultivar level. By nursery, the system can link individual plants into pre-defined Plant Groups. The system can then select the appropriate plant(s), based on price, to extract from the nursery data and use it to fulfill the business rules discussed above with respect to aggregating wholesale prices to provide national averages and selecting the nursery prices reflective of “Standard” quality and “Premium” quality plants. For nurseries with multiple plants within a Plant Group, the system can create an average at listed sizes of all of the prices for each plant in the Group. The average listed prices can be used to derive (extrapolate or interpolate) the price vertical for a Plant Group from each nursery for each Class. To identify outliers, the system may be programmed to select the highest priced cultivar and compare it against the lowest priced cultivar (at identical plant sizes). If the difference is greater that 20% of the highest priced cultivar's price then the nursery can be labeled as invalid for that plant group. For standalone prices at a single listed size, the system can also conduct a trend analysis on the price points for each nursery. The system labels a nursery as invalid if the prices either decrease, or increase at a price/foot of greater than 50% at larger sizes. For any pricing that falls outside of the tolerance of either test above, the system generates an exception report and does not include the pricing from this nursery for the affected Class. It may use the nursery for this Plant Group in other Class ranges.

The system and method in certain embodiments enables unique price multipliers to be applied based on a nursery or plant classification. By way of example, the wholesale price of Class 1 objects can be multiplied by 3.5, the wholesale price of Class 2 objects can be multiplied by 3.0, the wholesale price of Class 3 objects can be multiplied by 2.0,

The user is preferably provided with the ability to “lock-in” a Plant Group price/size vertical for a specific time period. In this respect, the system generates upon request reporting which identifies all Plant Groups and the data points available by Class and Quality. Subsequently, the system can make available to management the price vertical created by the above data. If management approves the Plant Group price vertical, then the system protects that Plant Group from subsequent new data entry. The System can also “save” the raw data by which the pricing vertical was constructed. The system further provides a function which enables management to approve (lock-out) contiguous class curves, without approving the entire Plant Group's curve. In other words, it is possible to have approved Class 1 and Class 2 verticals, without Class 3 approved. The user can support assessment sales in this scenario if the assessed plants grow only within the approved Class ranges. The system can further be programmed such that, on an annual basis, it indicates that a Plant Group's pricing needs to be updated and re-approved. At this point, any new pricing in the system can be reviewed for addition to the Plant Group's pricing vertical.

The system and method in certain embodiments thereof includes a pricing methodology for trees outside of the Maximum Commercially Available Size (MCAS) range. The MCAS reflects the largest size at which a plant is reasonably available for purchase from a commercial nursery. The pricing data collected from wholesale nurseries will be used to determine the MCAS for all plants in the system. The system creates a value that is consistent with the Basic Value (BV) component, minus the Species Rating (SR), within the CTLA Trunk Formula Method of tree valuation. The Basic Value formula is: BV=RC+[BP×(TAA−TAR)]×SR where:
RC=Replacement Cost at MCAS−HMI's assessed valuation with multiple applied.
BP=cost per square inch of trunk area at the MCAS
TAA=area of the trunk of the assessed tree
TAR=area of the trunk at MCAS
SR=Species Rating (not applicable to our System at this time)

In accordance with one embodiment, the system includes functionality for converting national average data to local/regional data. In this respect, the system should be able to account for local price variations to represent to the consumer the replacement value consistent with their location.

The system may further be programmed to determine, based on prior data, appropriate cross-over statistics: container to height, caliper to height. The underlying data used to perform this determination may consist of cross-over data provided directly by nurseries or contractors, along with field measurements provided by assessors.

The invention as described above provides a higher degree of accuracy, quality, and therefore value, for many applications, including but not limited to Property Insurance, Claims Adjusting, Tax Deductions, and Real Property Valuations/Assessments. In this respect, the invention may be used in combination with the methods and systems disclosed in U.S. patent application Ser. No. 10/719,741 filed Nov. 21, 2003, and U.S. patent application Ser. No. 10/642,865 filed Aug. 18, 2003, which are incorporated by reference in their entirety as if fully reproduced herein.

While the invention has been particularly shown and described with reference to a preferred embodiment thereof, it will be understood by those skilled in the art that various changes in form and details may be made therein without departing from the spirit and scope of the invention.

The embodiments of the invention in which an exclusive property or privilege is claimed are defined as follows:

1. A method for using a database to determine a current replacement value of landscape architectural objects, comprising the steps of:
identifying a landscape architectural object and its location;
using a database to compare identified landscape architectural objects of a specific type and at a specific size against known pricing information from nurseries;
using a result of said comparison to select valid nursery prices;
averaging said valid prices for landscape architectural objects at a single nursery to derive a nursery average;
deriving price points at sizes not being sold by the nursery to create a complete size/price curve for a nursery; and,
averaging said nursery curve with other valid nursery prices to construct at least one of: a national or regional average current replacement value.

2. The method for determining a current replacement value of landscape architectural objects in accordance with claim 1, further comprising the step of:
applying a market-based multiplier against derived average wholesale prices to accommodate for the professional installation of the landscape architectural object.

3. The method for determining a current replacement value of landscape architectural objects in accordance with claim 1, wherein said known pricing information from nurseries comprises known wholesale prices.

4. The method for determining a current replacement value of landscape architectural objects in accordance with claim 1, wherein said step of deriving price points comprises extrapolating price points.

5. The method for determining a current replacement value of landscape architectural objects in accordance with claim 1, wherein said step of deriving price points comprises interpolating price points.

6. The method for determining a current replacement value of landscape architectural objects in accordance with claim 1, further comprising the step of: using said national or regional average to create a report.

7. The method for determining a current replacement value of landscape architectural objects in accordance with claim 1, further comprising the step of:
displaying said national or regional average to a user.

8. The method for determining a current replacement value of landscape architectural objects in accordance with claim 1, further comprising the step of:
uploading said identification of said landscape architectural object to said database.

9. The method for determining a current replacement value of landscape architectural objects in accordance with claim 1, wherein said database comprises a relational database.

10. The method for determining a current replacement value of landscape architectural objects in accordance with claim 1, further comprising the step of:
utilizing a business rule requiring that, in order for a data point to be valid and included in a price average for a region, data from at least two nurseries in said region must be present.

11. The method for determining a current replacement value of landscape architectural objects in accordance with claim 1, further comprising the step of:
utilizing a business rule which prevents the system from performing extrapolation using data for architectural elements which differ in height from an architectural element of interest by more than a predetermined value.

12. The method for determining a current replacement value of landscape architectural objects in accordance with claim 1, further comprising the step of using said national or regional average current replacement value in an application selected from the group consisting of: property insurance, claims adjusting, legal, tax deductions, and real property valuations/assessments.

13. The method for determining a current replacement value of landscape architectural objects in accordance with claim 1, further comprising the step of:
selecting nursery prices reflective of standard quality and premium quality plants; and,
constructing independent price verticals based on said selected nursery prices.

14. The method for determining a current replacement value of landscape architectural objects in accordance with claim 1, wherein said step of selecting valid nursery prices comprises selecting prices from a specific distribution channel.

15. The method for determining a current replacement value of landscape architectural objects in accordance with claim 14, wherein said step of selecting prices from a specific distribution channel comprises selecting data from records having a particular channel ID.

16. The method for determining a current replacement value of landscape architectural objects in accordance with claim 1, further comprising the step of utilizing a cost of living adjustment (COLA) to normalize said valid prices for landscape architectural objects at a single nursery to a national average.
